(19) United States
(12) Patent Application Publication
(10) Pub. No.: US 2010/0110432 A1
(43) Pub. Date: May 6, 2010

(54) METHOD AND SYSTEM FOR EVALUATING OPTICAL PROPERTIES OF COMPENSATION LAYER

(75) Inventors: Kazuto Yamagata, Ibaraki-shi (JP); Shusaku Nakano, Ibaraki-shi (JP); Tsuyoshi Kashima, Ibaraki-shi (JP); Rie Hayashiuchi, Ibaraki-shi (JP); Toshimasa Nishimori, Ibaraki-shi (JP); Masayo Hirose, Ibaraki-shi (JP); Hidetoshi Maikawa, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/520,203

(22) PCT Filed: Feb. 20, 2008
(86) PCT No.: PCT/JP2008/052794

§ 371 Date: Jun. 19, 2009

(30) Foreign Application Priority Data
Feb. 28, 2007 (JP) 2007-049916

(51) Int. Cl. G01J 4/00

(52) U.S. Cl. 356/365

(57) ABSTRACT

A compensation layer optical property evaluation method capable of precisely and accurately evaluating the optical properties of the compensation layer without separating the compensation layer from the optical film, namely without causing a breakage of the compensation layer or a change in the optical properties, and to provide a compensation layer optical property evaluation system for use in such a method. The method for evaluating the optical properties of a compensation layer in an optical film comprising at least a polarizer and the compensation layer placed thereon, comprising the steps of: preparing the optical property data that represent the relationship between the ellipticity of polarized light and optical properties of the compensation layer, wherein the optical properties include front retardation R₀, thickness retardation Rₜₕ, bonding angle θ, and average tilt angle β; measuring the ellipticity of polarized light through a sample of the optical film,; extracting the optical property data equal or close to the measured ellipticity of the polarized light from the data prepared in the data preparing step.

### TECHNICAL FIELD

The invention relates to a method and system for evaluating the optical properties of a compensation layer in an optical film including at least a polarizer and the compensation layer placed thereon.

### BACKGROUND ART

FIG. 1 shows an optical film including a polarizer and a compensation layer placed thereon. More specifically, the optical film includes the compensation layer, a triacetylcellulose film (a TAC film functioning as a protective film layer), the polarizer (such as a PVA film), and another TAC film (functioning as another protective film layer) which are laminated with an adhesive interposed between each pair of adjacent layers.

General retardation measurement systems have been used to evaluate optical properties. Such systems are used to evaluate the optical properties of the whole of a sample being measured. Therefore, only a layer part of such a sample cannot be evaluated using such systems. Patent Literature 1 discloses a polarized light measuring method and device for measuring the azimuth angle (φ) and the ellipticity (ρ) (optical properties) of elliptically polarized light.

Patent Literature 1: Japanese Patent Application Laid-Open (JP-A) No. 04-297835

### DISCLOSURE OF THE INVENTION

### Problems to be Solved by the Invention

If defects occur in the whole or part of a raw material for the optical film shown in FIG. 1, the optical properties of the compensation layer should be evaluated in the manufacturing process, the quality checking process for shipping decision, or the like. However, it is difficult to separate only the compensation layer from the optical film, because the compensation layer is fixed and bonded to the polarizer, the TAC film or the like with the adhesive. Even if the compensation layer is separated, its optical properties undergo a change due to stress caused by a breakage or separation of it so that its optical properties cannot be accurately evaluated.

The invention has been made in view of the above circumstances, and an object of the invention is to provide a compensation layer optical property evaluation method capable of precisely and accurately evaluating the optical properties of the compensation layer without separating the compensation layer from the optical film, namely without causing a breakage of the compensation layer or a change in the optical properties, and to provide a compensation layer optical property evaluation system for use in such a method.

### Means for Solving the Problems

As a result of investigations to solve the above problems, the invention described below has been completed.

The method for evaluating the optical properties of a compensation layer in an optical film according to the present invention is the method for evaluating the optical properties of a compensation layer in an optical film comprising at least a polarizer and the compensation layer placed thereon, comprising the steps of:

preparing the optical property data that represent the relationship between the ellipticity of polarized light and optical properties of the compensation layer, wherein the optical properties include front retardation R₀, thickness retardation Rₜₕ, bonding angle θ, and average tilt angle β;

measuring the ellipticity of polarized light through a sample of the optical film,;

extracting the optical property data equal or close to the measured ellipticity of the polarized light from the data prepared in the data preparing step,

wherein the ellipticity measuring step, natural light is applied to a polarizer side surface of the optical film at a given angle with respect to a horizontal surface of the optical film, and the optical film is rotated about a vertical axis of the horizontal surface of the optical film, when the ellipticity of the polarized light is measured.

The feature described above produces advantageous effects as described below. The compensation layer optical property evaluation method includes the steps described below. Specifically, the method includes the steps of previously preparing data that represent the relationship between the ellipticity of polarized light and the optical properties of the compensation layer, which include front retardation R₀, thickness retardation Rₜₕ, bonding angle θ, and average tilt angle β (the optical property data preparing step); and measuring the ellipticity of polarized light through a sample of the optical film to be evaluated (the ellipticity measuring step). In the ellipticity measuring step, natural light is applied to the polarizer side surface of the optical film at a given angle with respect to the horizontal surface of the optical film, and the optical film is rotated about the vertical axis of the horizontal surface of the optical film, when the ellipticity of the polarized light is measured. This process allows precise measurement of the ellipticity of polarized light through the compensation layer of the optical film. Then, the data prepared in the optical property data preparing step are compared with the measured ellipticity data, and a data equal or close to the measured ellipticity of the polarized light is extracted (the optical property data extracting step). In this process, any type of data equal or close to the measured ellipticity of the polarized light can be extracted from the previously prepared data group, so that the optical properties of the compensation layer as a component of the optical film can be precisely evaluated without separation of the compensation layer from the optical film.

As an example of the preferred embodiments of the method for evaluating the optical properties of the compensation layer, the optical property data preparing step further comprises the step of theoretically calculating data representing the relationship between the ellipticity of polarized light and the optical properties including front retardation R₀, thickness retardation Rₜₕ, bonding angle θ, and average tilt angle β.

According to this feature, the ellipticity of polarized light can be calculated using freely set parameters such as the physical properties, thickness, front retardation R₀, thickness retardation Rₜₕ, bonding angle θ, and average tilt angle β of the compensation layer, and measurement conditions (such as light wavelength), so that data on the relationship between the ellipticity of polarized light and the front retardation R₀, thickness retardation Rₜₕ, bonding angle θ, and average tilt angle β can be readily prepared. The ellipticity of polarized light may be calculated using the following formula (I):

the ellipticity of polarized light=(the minor axis of the ellipse of polarized light)/(the major axis)

For example, using LCD Master Simulation System manufactured by Symantec Corporation as calculation mean, data on the relationship between the ellipticity of polarized light and the front retardation R₀, thickness retardation Rₜₕ, bonding angle θ, and average tilt angle β can also be readily prepared.

As an example of the preferred embodiments of the method for evaluating the optical properties of the compensation layer, the optical property data preparing step further comprises the step of measuring, by measurement means, data representing the relationship between the ellipticity of polarized light and the optical properties including front retardation R₀, thickness retardation Rₜₕ, bonding angle θ, and average tilt angle β.

According to this feature, the optical properties of the compensation layer, which includes front retardation R₀, thickness retardation Rₜₕ, bonding angle θ, and average tilt angle β, and the ellipticity of polarized light can be measured, respectively, using the measurement means, so that data on the relationship between the ellipticity of polarized light and the front retardation R₀, thickness retardation Rₜₕ, bonding angle θ, and average tilt angle β can be accurately prepared.

For example, the measurement means may be a retardation measurement system.

As an example of the preferred embodiments of the method for evaluating the optical properties of the compensation layer, the data preparing step further comprises the steps of:

theoretically calculating data representing the relationship between the ellipticity of polarized light and the optical properties including front retardation R₀, thickness retardation Rₜₕ, bonding angle θ, and average tilt angle β;

measuring, by measurement means, data representing the relationship between the ellipticity of polarized light and the optical properties including front retardation R₀, thickness retardation Rₜₕ, bonding angle θ, and average tilt angle β; and

correcting the calculated data so that the corrected data can be an approximation to the measured data.

According to this feature, the theoretically calculated optical property data can be corrected using the measured optical property data, and corrected data can be readily prepared as approximations to measurement data from the theoretically calculated data. The process of performing measurement on all samples to prepare optical property data requires a relatively large amount of labor and time. Therefore, a correlation between measurement data and theoretically calculated data may be calculated, and the correlation may be used to correct the theoretically calculated data so that the corrected data can be used as approximations to the measurement data. Therefore, the theoretically calculated data having undergone the correction can be used as if they were measured data, so that optical property data with high accuracy can be readily prepared.

As an example of the preferred embodiments of the method for evaluating the optical properties of the compensation layer, in the optical property data extracting step, when four peak ellipticity values measured in the ellipticity measuring step are the same, a data equal or close to the peak value (data of the ellipticity) is extracted from the data prepared in the data preparing step so that the front retardation R₀, thickness retardation Rₜₕ, and average tilt angle β at a bonding angle θ of 0° can be determined.

According to this feature, when four peak ellipticity values measured in the ellipticity measuring step are the same, a data equal or close to the peak value (the peak ellipticity value) is extracted from the data prepared in the optical property data preparing step so that the front retardation R₀, thickness retardation Rₜₕ, and average tilt angle β at a bonding angle θ of 0° can be determined. As used herein, the term “close” is intended to include values in a certain range that may be considered substantially equal to a given value, such as the range of the given value ±1% of the given value. Such a range may be appropriately set depending on design specifications such as the physical properties and thickness of the compensation layer.

As an example of the preferred embodiments of the method for evaluating the optical properties of the compensation layer, in the optical property data extracting step, when four peak ellipticity values measured in the ellipticity measuring step are not the same, the average of the peak values is calculated, and a data equal or close to the calculated average peak value (peak ellipticity value) is extracted from the data prepared in the data preparing step so that the front retardation R₀, thickness retardation Rₜₕ, and average tilt angle β can be determined.

According to this feature, when four peak ellipticity values measured in the ellipticity measuring step are not the same, the average of the peak values is calculated, and a data (peak ellipticity value) equal or close to the calculated average peak value is extracted from the data prepared in the optical property data preparing step so that the front retardation R₀, thickness retardation Rₜₕ, and average tilt angle β can be determined. For example, when the compensation layer satisfies the relation nx>ny>nz, wherein nx is its refractive index in its slow axis direction, ny is its refractive index in its fast axis direction, and nz is its refractive index in its thickness direction, the four ellipticity peaks may form two peak pairs. These peak pairs will be described later. The four peak values may be averaged, and a value equal or close to the resulting average ellipticity may be extracted from the prepared data group. The extracted ellipticity data is associated with the front retardation R₀, thickness retardation Rₜₕ, and average tilt angle β. Therefore, the step of determining the ellipticity allows the determination of the front retardation R₀, thickness retardation Rₜₕ, and average tilt angle β.

As an example of the preferred embodiments of the method for evaluating the optical properties of the compensation layer, wherein the difference between the calculated average peak value and a maximum or minimum peak value is calculated, and a data equal or close to the calculated difference is extracted from data on peak ellipticity versus bonding angle θ shift prepared in the data preparing step so that the bonding angle β indicating axis misalignment in a bonding process can be determined.

According to this feature, the bonding angle θ can be readily evaluated when the four peak ellipticity values measured in the ellipticity measuring step are not the same. The difference between the calculated average peak value and the maximum or minimum peak value is calculated, and a data equal or close to the calculated difference is extracted from data on peak ellipticity versus bonding angle θ shift prepared in the optical property data preparing step so that the bonding angle θ indicating axis misalignment in the bonding process can be readily determined.

For example, when the compensation layer satisfies the relation nx>ny>nz, wherein nx is its refractive index in its slow axis direction, ny is its refractive index in its fast axis direction, and nz is its refractive index in its thickness direction, the four ellipticity peaks may form two peak pairs. For example, an ellipticity peak appearing at a rotation angle (called azimuth angle) of 0° to 90° around the vertical axis of the optical film surface (peak 3) is equal to another ellipticity peak appearing at an azimuth angle of −180° to −90° (peak 1). These peaks are referred to as a first peak pair. In addition, an ellipticity peak appearing at an azimuth angle of 90° to 180° (peak 4) is also equal to another ellipticity peak appearing at an azimuth angle of −90° to 0° (peak 2). These peaks are referred to as a second peak pair. These peak pairs are classified into a peak pair higher than the average peak value and another peak pair lower than the average peak value. This means that when the compensation layer satisfies the relation nx>ny>nz, wherein nx is its refractive index in its slow axis direction, ny is its refractive index in its fast axis direction, and nz is its refractive index in its thickness direction, and when the bonding angle θ is not zero so that axis misalignment occurs in the bonding process, a peak ellipticity higher than the average peak value and another peak ellipticity lower than the average peak value alternately appear.

As an example of the preferred embodiments of the method for evaluating the optical properties of the compensation layer, wherein

the ellipticity measuring step comprises using natural light with two different wavelengths to measure the ellipticities of two types of polarized light, and

the optical property data extracting step comprises extracting a data equal or close to each of the measured ellipticities of the two types of polarized light from the data prepared in the optical property data preparing step.

For example, when two optical film samples having different physical properties are measured for polarized light ellipticity using natural light with a single wavelength, the measured polarized light ellipticities may be equal to each other. In such a case, natural light with two different wavelengths should be used so that the ellipticities of two types of polarized light can be measured. When natural light with two different wavelengths is used, two different types of data on polarized light ellipticity can be obtained. Therefore, when two different optical film samples are measured for polarized light ellipticity, different ellipticity data can be obtained by the measurement at different wavelengths, while the ellipticities measured at a single wavelength are the same value. Consequently, when two different ellipticity values are used and compared with the data group prepared in the optical property data preparing step, the optical property data can be accurately evaluated. The data group prepared in the optical property data preparing step also contains light wavelength-dependent ellipticity data. In other words, data about two wavelengths at which the optical film sample will be measured are prepared.

As an example of the preferred embodiments of the method for evaluating the optical properties of the compensation layer, wherein

the ellipticity measuring step comprises applying natural light to a polarizer side surface of the optical film at two different angles with respect to the horizontal surface of the optical film to measure the ellipticities of two types of polarized light, and

the optical property data extracting step comprises extracting a data equal or close to each of the measured ellipticities of the two types of polarized light from the data prepared in the optical property data preparing step.

For example, when two optical film samples having different physical properties are measured for polarized light ellipticity using natural light with a single wavelength, the measured polarized light ellipticities may be equal to each other. In such a case, natural light may be applied to the polarizer side surface of the optical film at two different angles with respect to the horizontal surface of the optical film so that the ellipticities of two types of polarized light can be measured. This allows measurement of the ellipticities of two types of polarized light with a single sample. Therefore, when two different optical film samples are measured for polarized light ellipticity, different ellipticity data can be obtained by the measurement at different angles (incidence angles), while the ellipticities measured at a single angle (incidence angle) are the same value. Consequently, when two different ellipticity values are used and compared with the data group prepared in the optical property data preparing step, the optical property data can be accurately evaluated.

As an example of the preferred embodiments of the method for evaluating the optical properties of the compensation layer, a system for evaluating the optical properties of a compensation layer is exemplified below.

The system comprises at least a polarizer and the compensation layer placed thereon, comprising:

an optical property data storage unit for storing data that represent the relationship between the ellipticity of polarized light and optical properties of the compensation layer, wherein the optical properties include front retardation R₀, thickness retardation Rₜₕ, bonding angle θ, and average tilt angle β;

an ellipticity measurement device for measuring the ellipticity of polarized light through a sample of the optical film;

an optical property data extraction unit for extracting a data equal or close to the measured ellipticity of the polarized light from the data stored in the optical property data storage unit,

wherein measuring by the ellipticity measurement device, natural light is applied to a polarizer side surface of the optical film at a given angle with respect to a horizontal surface of the optical film, and the optical film is rotated about a vertical axis of the horizontal surface of the optical film, when the ellipticity of the polarized light is measured.

The advantageous effects of this feature are as described above.

### BRIEF DESCRIPTION OF THE DRAWINGS

FIG. 1 is a diagram showing an example of the structure of the optical film;

FIG. 2 is a block diagram showing a functional configuration of a system for evaluating the optical properties of a compensation layer;

FIG. 3 is a flow chart for illustrating the operation of a system for evaluating the optical properties of a compensation layer;

FIG. 4 is a graph for illustrating approximate curves for actual measurement data and simulation data on average peak ellipticity values;

FIG. 5 is a diagram for illustrating ellipticity measuring methods;

FIG. 6 is a graph showing exemplary ellipticity measurements versus azimuth angles;

FIG. 7 is a graph showing exemplary ellipticity measurements versus azimuth angles in a case where axis misalignment occurs;

FIG. 8 is a graph for illustrating calculation of the average of peak ellipticity values;

FIG. 9 shows exemplary simulation data and actual measurement data; and

FIG. 10 shows exemplary ellipticity values at different wavelengths.

### DESCRIPTION OF REFERENCE NUMERAL

1 a system for evaluating the optical properties of a compensation layer
11 an input unit
12 an optical property data storage unit
13 a data correction unit
14 an ellipticity measurement device
15 an ellipticity data storage unit
16 an optical property data extraction unit
17 a display unit
18 a monitor
21 an ellipticity calculation means
22 an optical property data measurement means

### BEST MODE FOR CARRYING OUT THE INVENTION

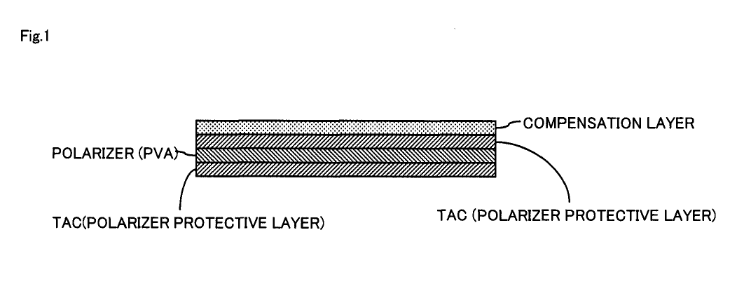

Preferred embodiments of the invention are described below with reference to the drawings. FIG. 1 shows an example of the optical film.

Optical Film

In an embodiment of the invention, the optical film typically includes a polarizer having an optical axis and a compensation layer placed thereon. The optical film shown in FIG. 1 includes a polarizing plate and a compensation layer placed on the polarizing plate, wherein the polarizing plate includes a polarizer and a polarizer protective layer (TAC) formed on one side of the polarizer. The compensation layer is typically a retardation layer, a discotic liquid crystal layer or any other layer that satisfied the relation nx>ny>nz, wherein nx is the refractive index in the slow axis direction, ny is the refractive index in the fast axis direction, and nz is the refractive index in the thickness direction. Based on this structure, a surface protective film or a separator may be provided as an outermost layer of the optical film.

Polarizer or Polarizing Plate

The polarizer to be used may be of any type. For example, the polarizer may be a product produced by the steps of adsorbing a dichroic material such as iodine or a dichroic dye onto a hydrophilic polymer film such as a polyvinyl alcohol-based film, a partially-formalized polyvinyl alcohol-based film, or a partially-saponified ethylene-vinyl acetate-based copolymer film and stretching the film or may be a polyene-based oriented film such as a dehydration product of a polyvinyl alcohol film or a dehydrochlorination product of a polyvinyl chloride film. The thickness of the polarizer is generally, but not limited to, from 5 to 80 μm. The thickness of the polarizer may be controlled by any conventional method such as tentering, roll stretching, or rolling.

In particular, a polarizer produced by stretching a polyvinyl alcohol-based film and adsorbing and orienting a dichroic material (iodine or dye) on the film is preferably used. The processes of dyeing, crosslinking and stretching the polyvinyl alcohol film are not necessarily independently performed and may be performed at the same time or in any order. The polyvinyl alcohol-based film may be subjected to a swelling process before use. The process may generally include the steps of immersing the polyvinyl alcohol film in a solution containing iodine or a dichroic dye so that the film is dyed with the iodine or the dichroic dye being adsorbed thereon, then washing the film, uniaxially stretching the film to 3 to 7 times in a solution containing boric acid, borax or the like, and then drying the film. It is particularly preferred that the step of stretching the film in a solution containing iodine or a dichroic dye should be followed by the steps of further stretching the film in a solution containing boric acid, borax or the like (two-stage stretching) and then drying the film, so that the iodine can be highly oriented to provide good polarizing properties.

For example, the polyvinyl alcohol-based polymer may be a polymer produced by polymerizing vinyl acetate and then saponifying the polymer or a copolymer produced by copolymerizing vinyl acetate with a small amount of a copolymerizable monomer such as an unsaturated carboxylic acid, an unsaturated sulfonic acid, or a cationic monomer. The average polymerization degree of the polyvinyl alcohol-based polymer is preferably, but not limited to, 1,000 or more, more preferably from 2,000 to 5,000. The saponification degree of the polyvinyl alcohol-based polymer is preferably 85% by mole or more, more preferably from 98 to 100% by mole.

Any appropriate transparent film may be used as the polarizer protective film to be placed on one or both sides of the polarizer. In particular, a film comprising a polymer with a high level of transparency, mechanical strength, thermal stability, or water-blocking performance is preferably used. Examples of such a polymer include acetate-based resins such as triacetylcellulose, polycarbonate-based resins, polyester-based resins such as polyarylate-based and polyethylene terephthalate, polyimide-based resins, polysulfone-based resins, polyethersulfone-based resins, polystyrene-based resins, polyolefin-based resins such as polyethylene and polypropylene, polyvinyl alcohol-based resins, polyvinyl chloride-based resins, polynorbornene-based resins, poly(methyl methacrylate)-based resins, and liquid crystal polymers. The film may be produced by any of a casting method, a calender method and an extrusion method.

The polymer film described in JP-A No. 2001-343529 (WO01/37007) may also be used, for example, which comprises a resin composition containing (A) a thermoplastic resin having a substituted and/or unsubstituted imide group in the side chain and (B) a thermoplastic resin having a substituted and/or unsubstituted phenyl and nitrile groups in the side chain. Specifically, the film comprises a resin composition containing an alternating copolymer of isobutylene and N-methylmaleimide and an acrylonitrile-styrene copolymer. The film may be produced by mixing-extrusion of the resin composition. These films have a low level of retardation and photoelastic coefficient and thus can prevent polarizing plates from having defects such as strain-induced unevenness. They also have low water-vapor permeability and thus have high humidity resistance.

The polarizer protective film is preferably as colorless as possible. Therefore, the protective film to be used preferably has a retardation of −90 nm to +75 nm in its thickness direction, wherein the retardation (Rth) in the thickness direction is expressed by the formula Rth=(nx−nz)/d, wherein nx is the refractive index in the slow axis direction, ny is the refractive index in the fast axis direction, nz is the refractive index in the thickness direction, and d is the thickness of the film. When the protective film used has a retardation (Rth) of −90 nm to +75 nm in its thickness direction, protective film-induced coloration of polarizing plates (optical coloration) can be substantially avoided. The retardation (Rth) in the thickness direction is more preferably from −80 nm to +60 nm, particularly preferably from −70 nm to +45 nm.

In view of polarizing properties and durability, acetate-based resins such as triacetylcellulose are preferred, and a triacetylcellulose film whose surface has been saponified with an alkali or the like is particularly preferred.

While the polarizer protective film may have any thickness, it generally has a thickness of 500 μm or less, preferably of 1 to 300 μm, particularly preferably of 5 to 200 μm, in order to form a relatively thin polarizing plate. When transparent protective films are provided as polarizer protective layers on both sides of the polarizing film, the front and back transparent protective films may comprise different polymers.

The polarizer protective film may be subjected to hard coat treatment, anti-reflection treatment, anti-sticking treatment, diffusion or antiglare treatment, or the like, as long as the effects of the invention are not reduced. Hard coat treatment may be performed in order to prevent scratches on the polarizing plate surface and the like. The hard coat may be formed by a method including making a cured film with a high level of hardness and smoothness on the surface of the transparent protective film from an appropriate ultraviolet-curable resin such as a silicone-based resin.

Anti-reflection treatment may be performed in order to prevent reflection of external light on the polarizing plate surface. It may be achieved by forming an anti-reflection film or the like according to conventional techniques. Anti-sticking treatment may be performed in order to prevent sticking to the adjacent layer, and antiglare treatment may be performed in order to prevent interference from reflection of external light on the polarizing plate surface to visibility of light transmitted through the polarizing plate. The anti-sticking or antiglare part may be formed by providing fine irregularities on the surface of the transparent protective film by any appropriate method such as a surface roughening method such as sand blasting or embossing or a method of mixing transparent fine particles.

For example, the transparent fine particles may be silica, alumina, titania, zirconia, tin oxide, indium oxide, cadmium oxide, antimony oxide, or the like with an average particle size of 0.5 to 20 μm. Electrically-conductive inorganic fine particles or organic fine particles of a crosslinked or uncrosslinked particulate polymer may also be used. The transparent fine particles are generally used in an amount of 2 to 70 parts by mass, particularly in an amount of 5 to 50 parts by mass, based on 100 parts by mass of the transparent resin.

The transparent fine particles-containing antiglare layer may also be formed as the transparent protective layer itself or as a coating layer on the surface of the transparent protective layer. The antiglare layer may also serve as a diffusion layer (with a viewing angle compensation function or the like) to diffuse light being transmitted through the polarizing plate and to expand the viewing angle. The anti-reflection layer, the anti-sticking layer, the diffusion layer, the antiglare layer, or the like may be provided as an optical layer of a sheet having such a functional layer independent of the transparent protective layer.

An adhesive layer may be interposed between the polarizer and the polarizer protective layer (such as TAC). Examples of an adhesive that may be used to form the adhesive layer include an adhesive including a vinyl alcohol-based polymer and an adhesive including a vinyl alcohol-based polymer and a water-soluble crosslinking agent therefor such as glutaraldehyde, melamine, or oxalic acid. The adhesive layer may be formed by applying and drying an aqueous solution layer. In the process of preparing the aqueous solution, if necessary, any other additive or a catalyst such as an acid may also be added.

In an embodiment of the invention, for example, the surface of the optical film on the side where the polarizer is not bonded to the transparent protective film (the surface on which the adhesive coating layer is not provided) may be subjected to hard coat treatment, anti-reflection treatment, or surface treatment to impart anti-sticking, diffusion or antiglare properties.

Compensation Layer

The structure of the compensation layer according to the invention is specifically described below. For example, a method for forming the compensation layer includes placing an oriented liquid crystal layer (to function as the compensation layer) for viewing angle compensation or the like on the polarizer. Examples of the compensation layer include a retardation plate (including a wave plate (λ plate) such as a half-wave plate and a quarter wavelength plate), and a viewing angle compensation film. One or more of these layers may be used alone or laminated to form the compensation layer. In an embodiment of the invention, the optical film may also be an elliptically or circularly polarizing plate formed by laminating a retardation plate and a polarizing plate or may also be a wide-viewing-angle polarizing plate or a brightness enhancement film formed by laminating a viewing angle compensation layer or film and a polarizing plate.

A description is given below of the elliptically or circularly polarizing plate. Retardation plates or the like are used to convert linearly polarized light into elliptically or circularly polarized light, to convert elliptically or circularly polarized light into linearly polarized light or to change the direction of polarization of linearly polarized light. Specifically, so-called quarter wavelength plates (also referred to as λ/4 plates) are used as retardation plates to convert linearly polarized light into circularly polarized light or convert circularly polarized light into linearly polarized light. Half-wave plates (also referred to as λ/2 plates) are generally used to change the direction of polarization of linearly polarized light.

The elliptically polarizing plate is effectively used in cases where coloration (blue or yellow) caused by the birefringence of a liquid crystal layer in a super-twisted nematic (STN) liquid crystal display should be compensated for (canceled) so that white and black can be displayed without the coloration. The elliptically polarizing plate with controlled three-dimensional refractive indices is also preferred, because it can also compensate for (cancel) coloration that occurs when the screen of a liquid crystal display is obliquely viewed. For example, the circularly polarizing plate is effectively used in cases where the tone of color images displayed by a reflective liquid crystal display should be adjusted. The circularly polarizing plate can also have an anti-reflection function.

Examples of the retardation plate include birefringent films produced by uniaxially or biaxially stretching polymer materials, oriented liquid crystal polymer films, and oriented liquid crystal polymer layers supported on films. The stretching process may be typically performed by roll stretching, long-gap stretching, tenter stretching, or tubular stretching. Uniaxial stretching is generally performed to a stretch ratio of about 1.1 to about 3. The thickness of the retardation plate is generally, but not limited to, from 10 to 200 μm, preferably from 20 to 100 μm.

Examples of the polymer materials used to form polarizing plates include polyvinyl alcohol, polyvinyl butyral, poly(methyl vinyl ether), poly(hydroxyethyl acrylate), hydroxyethyl cellulose, hydroxypropyl cellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyvinyl alcohol, polyamide, polyimide, polyolefin, polyvinyl chloride, cellulose polymers, and various types of binary or ternary copolymers thereof, graft copolymers thereof, and any blend thereof. Any of these polymer materials may be formed into an oriented product (a stretched film) by stretching or the like.

Examples of the liquid crystal polymer include various main-chain or side-chain types having a conjugated linear atomic group (mesogen) that is introduced in the main or side chain of the polymer to impart liquid crystal molecular orientation. Examples of the main chain type liquid crystal polymer include polymers having a mesogenic group bounded thereto through a flexibility-imparting spacer moiety, such as nematically oriented polyester-based liquid-crystalline polymers, discotic polymers, and cholesteric polymers. For example, the side-chain type liquid crystal polymer may be a polymer comprising: a main chain skeleton of polysiloxane, polyacrylate, polymethacrylate, or polymalonate; and a side chain having a mesogenic moiety that comprises a nematic orientation-imparting para-substituted cyclic compound unit and is bonded thereto through a spacer moiety comprising a conjugated atomic group. For example, any of these liquid crystal polymers may be applied by a process that includes: spreading a solution of the liquid crystal polymer on an orientation surface, such as a rubbed surface of a thin film of polyimide, polyvinyl alcohol or the like or an obliquely vapor-deposited silicon oxide surface, formed on a glass plate; and heat-treating the solution.

The retardation plate may have any appropriate retardation depending on the intended use such as compensation for coloration, viewing angle, or the like associated with the birefringence of various wave plates or liquid crystal layers. Two or more types of retardation plates may also be laminated to provide controlled optical properties such as controlled retardation.

The viewing angle compensation film is for expanding the viewing angle so that images can be relatively clearly viewed even when the screen of a liquid crystal display is viewed from directions not perpendicular but somewhat oblique to the screen. Examples of such a viewing angle compensation retardation plate include a retardation film, an oriented film of a liquid crystal polymer or the like, and an oriented layer of a liquid crystal polymer or the like supported on a transparent substrate. General retardation plates are produced with a polymer film that is uniaxially stretched in the in-plane direction and has birefringence. On the other hand, retardation plates for use as viewing angle compensation films are produced with a bi-directionally stretched film such as a polymer film that is biaxially stretched in the in-plane direction and has birefringence, a polymer film that is uniaxially stretched in the in-plane direction and also stretched in the thickness direction so that it has a controlled refractive index in the thickness direction and has birefringence, or an obliquely oriented film. Examples of the obliquely oriented film include a film produced by a process including bonding a heat-shrinkable film to a polymer film and stretching and/or shrinking the polymer film under the action of the heat-shrinkage force, and an obliquely-oriented liquid crystal polymer film. The raw material polymer for the retardation plate may be the same as the polymer described above for the retardation plate, and any appropriate polymer may be used depending on the purpose such as prevention of coloration caused by changes in viewing angle based on the retardation of a liquid crystal cell or expansion of the viewing angle at which good visibility is achieved.

In order to expand the viewing angle at which good visibility is achieved, an optical compensation retardation plate is preferably used that includes a triacetylcellulose film and an optically-anisotropic layer of an oriented liquid crystal polymer, specifically an obliquely-oriented discotic liquid crystal polymer layer, supported on the film.

A laminate of the polarizing plate and the brightness enhancement film is generally placed on the back side of a liquid crystal cell, when used. The brightness enhancement film exhibits the property that when light is incident on it from a backlight of a liquid crystal display or the like or when natural light is reflected on the back side and incident on it, it reflects linearly polarized light with a specific polarization axis or reflects circularly polarized light in a specific direction and transmits the other part of the light. When light from a light source such as a backlight is incident on the laminate of the polarizing plate and the brightness enhancement film, transmitted light in a specific polarization state is produced, and light in any other state than the specific polarization sate is not transmitted but reflected. The light reflected from the surface of the brightness enhancement film may be reversed by a reflective layer or the like provided behind the brightness enhancement film and allowed to reenter the brightness enhancement film so that the light can be entirely or partially transmitted in the specific polarization state. Therefore, the quantity of the light transmitted through the brightness enhancement film can be increased, and polarized light, which is less likely to be absorbed by the polarizer, can be supplied so that the brightness can be enhanced by increasing the quantity of the light available at a liquid crystal display or the like. If the brightness enhancement film is not used in the process of allowing light from a backlight or the like to enter a liquid crystal cell from the back side through a polarizer, light whose polarization direction does not coincides with the polarization axis of the polarizer will be almost absorbed (not transmitted) by the polarizer. Therefore, about 50% of the light can be absorbed by the polarizer, depending on the characteristics of the polarizer, so that the quantity of the light available for image display on a liquid crystal display or the like can be reduced and that the brightness of the image can be lowered. Light that has a polarization direction such that it can be absorbed by the polarizer is not allowed to enter but temporarily reflected by the brightness enhancement film and then reversed by a reflective layer or the like placed behind the brightness enhancement film and allowed to reenter the brightness enhancement film. This process is repeated so that the brightness enhancement film can transmit polarized light to the polarizer only when the polarized light reflected and reversed by them has a polarization direction such that it can pass through the polarizer. Therefore, the brightness enhancement film allows efficient use of light from a backlight or the like for image display on a liquid crystal display and thus allows an increase in the brightness of the screen.

The diffusion plate may also be placed between the brightness enhancement film and the reflective layer or the like. When the polarized light reflected from the brightness enhancement film goes to the reflective layer or the like, the diffusion plate placed therebetween can uniformly diffuse the light passing therethrough and simultaneously cancel the polarization state to produce an unpolarized state. Namely, the diffusion plate can convert polarized light back into natural light in the initial state. The light in the unpolarized state, namely in the natural light state, goes to the reflective layer or the like and is reflected therefrom and passes through the diffusion plate again and reenter the brightness enhancement film. This process is repeated. Therefore, the diffusion plate that is placed between the brightness enhancement film and the reflective layer or the like to convert the polarization state back into the initial natural light state can reduce unevenness of the brightness of the display screen, while maintaining the brightness of the display screen, so that the resulting screen can be uniform and bright. When the diffusion plate is provided as described above, the number of times of repeated reflection of the initial incident light can be properly increased so that a bright uniform display screen can be provided together with the diffusion function of the diffusion plate.

Examples of the brightness enhancement film that may be used include a film having the property of transmitting linearly polarized light with a specific polarization axis and reflecting the other type of light, such as a dielectric multilayer thin film or a multilayer laminate of thin films different in refractive index anisotropy, and a film having the property of reflecting one of clockwise circularly polarized light and counterclockwise circularly polarized light and transmitting the other, such as an oriented cholesteric liquid crystal polymer film or an oriented cholesteric liquid crystal layer supported on a film substrate.

When the brightness enhancement film having the property of transmitting linearly polarized light with a specific polarization axis is used, the light transmitted therethrough may be allowed to directly enter the polarizing plate, while the polarization axis is aligned, so that the light can be efficiently transmitted, while the absorption loss of the polarizing plate can be reduced. When the brightness enhancement film having the property of transmitting circularly polarized light, such as the cholesteric liquid crystal layer, is used, the transmitted circularly polarized light may be allowed to directly enter the polarizer. In order to reduce the absorption loss, however, it is preferred that the transmitted circularly polarized light should be converted into linearly polarized light through a retardation plate and then allowed to enter the polarizing plate. When a quarter wavelength plate is used as the retardation plate, the circularly polarized light can be converted into linearly polarized light.

A retardation plate functioning as a quarter wavelength plate in a wide wavelength range such as the visible light range may be produced by laminating a retardation layer functioning as a quarter wavelength plate for monochromatic light such as light with a wavelength of 550 nm and another retardation layer exhibiting other retardation properties, such as a retardation layer functioning as a half-wave plate. Therefore, the retardation plate placed between the polarizing plate and the brightness enhancement film may include one or more retardation layers.

Two or more cholesteric liquid crystal layers with different reflection wavelengths may also be laminated to form a combined structure capable of reflecting circularly polarized light in a wide wavelength range such as the visible light range. Based on the combined structure, circularly polarized light in a wide wavelength range can be transmitted.

In an embodiment of the invention, the optical film may comprise a laminate of a polarizing plate and two or more optical layers (or compensation layers), like the polarized light-separating polarizing plate described above. Therefore, the optical film may also be a reflective or transflective elliptically polarizing plate that includes a combination of the reflective or transflective polarizing plate and a retardation plate.

The optical film comprising a laminate of the polarizing plate and the optical layer may be formed by a method of stacking them one by one in the process of manufacturing a liquid crystal display or the like. However, an optical film formed by previous lamination has the advantage that it can facilitate the process of manufacturing a liquid crystal display or the like, because it has stable quality and good assembling workability. In the lamination, any appropriate bonding means such as an adhesive layer may be used. When the polarizing plate and any other optical layer are bonded together, their optical axes may be each aligned at an appropriate angle, depending on the desired retardation properties or other desired properties.

In an embodiment of the invention, the optical film or the optical component to be placed on something may have a pressure-sensitive adhesive layer for bonding it to any other component such as a liquid crystal cell. The pressure-sensitive adhesive layer may be made of any appropriate pressure-sensitive adhesive such as an acrylic pressure-sensitive adhesive according to conventional techniques. The pressure-sensitive adhesive layer preferably has low moisture absorption coefficient and high heat resistance, in order to prevent moisture absorption-induced foaming or peeling, to prevent optical property degradation due to a thermal expansion difference or the like, to prevent warping of a liquid crystal cell, and to form an image display with high quality and high durability. The pressure-sensitive adhesive layer may also contain fine particles so as to have light diffusing properties. The pressure-sensitive adhesive layer may be provided as needed on a necessary surface. Concerning the polarizing plate including the polarizer and the polarizer protective layer, for example, a pressure-sensitive adhesive layer may be provided as needed on one or both sides of the polarizer protective layer.

In an embodiment of the invention, an ultraviolet absorbing capability may be imparted to any one of the layers of the polarizing plate, such as the polarizer, the polarizer protective layer, the compensation layer, or the pressure-sensitive adhesive layer, by treatment with an ultraviolet-absorbing agent such as a salicylate ester-based compound, a benzophenol-based compound, a benzotriazole-based compound, a cyanoacrylate-based compound, or a nickel complex salt-based compound.

Surface Protective Film and Separator

The surface protective film or the separator may include a base film made of a plastic film and an easily-peelable pressure-sensitive adhesive layer that is provided on one side of the base film and can be releasably attached to the surface of the polarizing plate.

For example, but not limited to, a biaxially-stretched film of polypropylene, polyester or the like is preferably used as the base film for the surface protective film or the separator. The thickness of the base film is preferably, but not limited to, from about 10 to about 200 μm.

Any appropriate pressure-sensitive adhesive may be used to form a pressure-sensitive adhesive layer that is interposed between the surface protective film and the polarizer protective layer. For example, any of acrylic, synthetic rubber-based, and rubber-based pressure-sensitive adhesives may be used to form the pressure-sensitive adhesive layer. In particular, the acrylic pressure-sensitive adhesive is preferred, because its adhesive strength can be easily controlled by changing its composition. If necessary, the pressure-sensitive adhesive may appropriately contain a crosslinking agent, a tackifier, a plasticizer, a filler, an antioxidant, an ultraviolet absorbing agent, a silane coupling agent, or the like. The pressure-sensitive adhesive layer may be formed by subjecting the surface protective film or the polarizing plate to a transfer method, a direct print method, a co-extrusion method, or the like. The thickness (dry thickness) of the pressure-sensitive adhesive layer is generally, but not limited to, about 5 to about 50 μm.

Various types of pressure-sensitive adhesives such as acrylic, synthetic rubber-based, and rubber-based pressure-sensitive adhesives may be used to form the pressure-sensitive adhesive layer that is interposed between the separator and the polarizer protective layer. Examples of materials for the separator include paper and films of synthetic resin such as polyethylene, polypropylene or polyethylene terephthalate. If necessary, the surface of the separator may be subjected to release treatment such as silicone treatment, long-chain alkyl treatment, and fluorine treatment in order to increase the releasability from the pressure-sensitive adhesive layer.

Examples of the Use of the Optical Film

In an embodiment of the invention, the optical film is preferably used to form an image display (corresponding to the optical display) such as a liquid crystal display device, an organic electroluminescence display device (organic EL display device) or a plasma display panel (PDP).

In an embodiment of the invention, the optical film is preferably used to form any of various devices such as liquid crystal displays. Liquid crystal displays may be formed according to conventional techniques. Specifically, a liquid crystal display may be typically formed by assembling a liquid crystal cell (corresponding to the optical display unit) and the polarizing plate or the optical film, and optional components such as a lighting system and incorporating a driving circuit, according to conventional techniques, except that the optical film is used according to the invention. The liquid crystal cell to be used may also be of any type such as TN type, STN type or n type. Any appropriate type of liquid crystal cell may also be used such as a simple matrix driving type, typified by a thin-film transistor type.

Any appropriate liquid crystal display may be formed such as a liquid crystal display including a liquid crystal cell and the optical film placed one or both sides of the liquid crystal cell or a liquid crystal display using a backlight or a reflector in a lighting system. In this case, the optical film according to the invention may be placed one or both sides of the liquid crystal cell. The optical films placed on both sides may be the same or different. In the process of forming the liquid crystal display, one or more layers of an additional appropriate component or components such as a diffusion plate, an antiglare layer, an anti-reflection film, a protective plate, a prism array, a lens array sheet, a light diffusion plate, or a backlight may also be placed at an appropriate location or locations.

### Method and System for Evaluating the Optical Properties of the Compensation Layer

### Embodiment 1

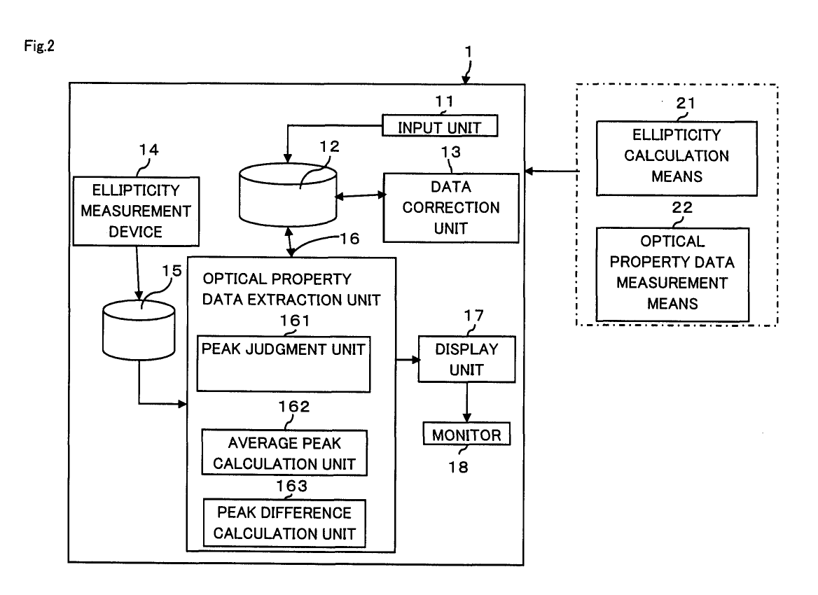

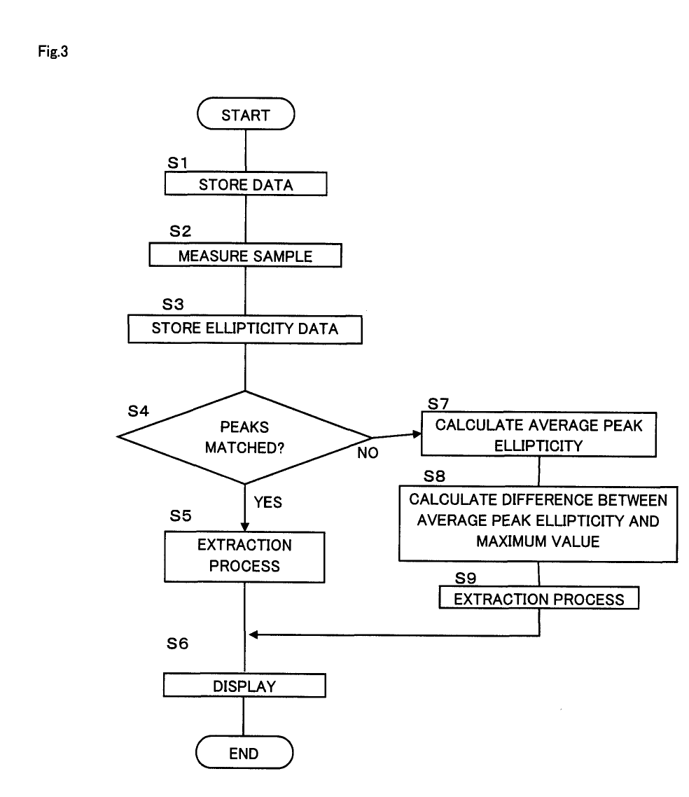

The features of the method of the invention for evaluating the optical properties of the compensation layer are described below with reference to the drawings. While the method of the invention will be described with an exemplary system for evaluating the optical properties of the compensation layer, it will be appreciated that the method of the invention may be practiced with other means than the system. FIG. 2 is a functional block diagram showing the configuration of a system for evaluating the optical properties of the compensation layer. FIG. 3 is a flow chart showing procedures for evaluating the optical properties of the compensation layer.

Each element of a system for evaluating the optical properties of the compensation layer shown in FIG. 2 will be described. A system 1 for evaluating the optical properties of the compensation layer includes an input unit 11 for inputting previously measured or calculated optical property data and an optical property data storage unit 12 for storing the optical property data input by the input unit 11. Input unit 11 typically includes a known input device such as a keyboard, a mouse, a touch panel, a data communication device, or a GUI for inputting data. Optical property data storage unit 12 may include a volatile or nonvolatile recording medium or the like and typically include a hard disk. A group of data to be stored in optical property data storage unit 12 may be converted into a database. Such a database may have a known database structure, as needed, and may be formed using database preparation means (not shown). Optical property data storage unit 12 may be configured so that only actually-measured optical property data or only optical property data calculated by, simulation can be stored or both of them can be stored. An optical property data extraction unit 16 as described later may be configured so that any of the data targeted for extraction can be selected.

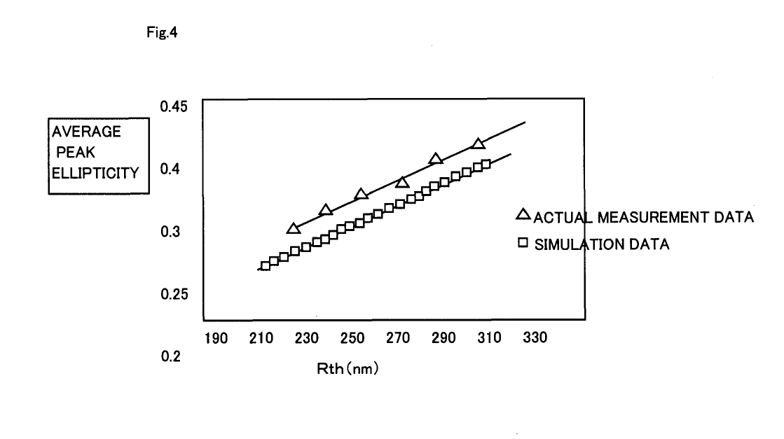

Concerning optical property data stored in the optical property data storage unit 12, the actually measured optical property data may slightly differ from the optical property data calculated by simulation. Therefore, system 1 includes a data correction unit 13 that analyzes the characteristics of each group of the data to calculate a correction parameter and applies the correction parameter to the optical property data obtained by simulation to calculate corrected optical property data. As shown in FIG. 4, for example, data correction unit 13 calculates the average of peak ellipticities (average peak ellipticity) from each set of the actual measurement data and the simulation data with respect to each thickness retardation Rₜₕ (R₀ is constant) and calculates an approximate curve (a linear curve in FIG. 4) with respect to each set of the averages, in which the approximate curve for the actual measurement data is y=0.0014x−0.025, and the approximate curve for the simulation data is y=0.0014x−0.022. The relationship between the approximate curves is then analyzed. The analysis may be performed using a known algorithm or analysis method. The result of this analysis shows that their gradients are the same. When a relationship in which their gradients of the data are the same is established, data correction unit 13 then calculates the difference between the average peak ellipticity on the linear curve for the simulation data and that for the actual measurement data, at a given Rₜₕ. The calculated difference value may then be added to the average peak ellipticity for the simulation date so that the average peak ellipticity for the simulation data can be corrected to approximate the actual measurement data. The correction method is not limited to the above, and any other appropriate method may be used. For example, an alternative method may include calculating an approximate curve for each parabola having a peak from the relationship between the ellipticity and the azimuth angle with respect to each set of the actual measurement data and the simulation data and comparing the resulting approximate curves with each other to calculate the difference between the peak values.

The simulation data can have a large amount of data, because the conditions can be finely set. In contrast, the actual measurement data require not only a large amount of measuring time in proportion to the amount of data but also a large amount of labor for the preparation of samples according to the set conditions. Therefore, actual measurement data are preferably complemented with simulation data. Specifically, a correlation may be calculated between a small amount of actual measurement data and a large amount of simulation data, and the resulting correlation may be used to complement the actual measurement data. For this purpose, the function of data correction unit 13l may be used, for example, in which at a certain Rₜₕ where no actual measurement data exists, the calculated difference value may be added to the average peak ellipticity for the simulation data, and the sum may be used as a complement to the actual measurement data. Alternatively to this method, for example, at a certain Rₜₕ where no actual measurement data exists, an ellipticity data may be derived from the linear curve for the actual measurement data and used as a complement to the actual measurement data.

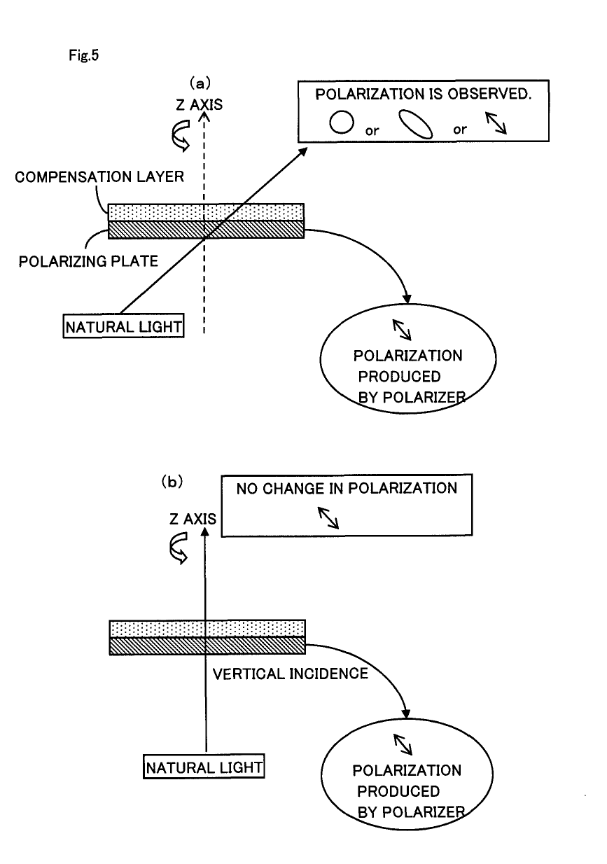

An ellipticity measurement device 14 may be used to measure the ellipticity of the polarized light through the compensation layer of the optical film. FIG. 5(a) shows an exemplary measurement method. As shown in FIG. 5(a), the process of measuring the ellipticity of the polarized light through the compensation layer may include applying natural light (unpolarized light) to the polarizer side surface of the optical film at a given angle (for example, an angle in the range of 10° to 80°) with respect to the horizontal surface of the optical film and rotating the optical film about the vertical axis (z axis) of the horizontal surface of the optical film. Herein, the rotation angle around the vertical axis is referred to as the azimuth angle. The ellipticity is measured with respect to the azimuth angle. FIG. 6 shows exemplary ellipticity data with respect to the azimuth angle. The sample used in the measurement is an optical film including the polarizing plate and the compensation layer placed thereon as shown in FIG. 1, in which the compensation layer used satisfies the relation nx>ny>nz, wherein nx is the refractive index in the slow axis direction, ny is the refractive index in the fast axis direction, and nz is the refractive index in the thickness direction. FIG. 6 shows that four ellipticity peaks appear.

The compensation layer and the polarizer are laminated to form the optical film. In general, the compensation layer and the polarizer are bonded together so that the absorption axis of the polarizer can coincide with the slow axis of the compensation layer. In the case of a defective, however, the angle between the axes of the bonded compensation layer and polarizer may be misaligned (namely, the bonding angle θ is not zero). Hereinafter, the bonding misalignment may be referred to as axis misalignment.

As shown in FIG. 5(b), when no axis misalignment occurs, the polarization of natural light perpendicularly entering the surface of the optical film and passing through the compensation layer is the same as that of the natural light passing through the polarizer, so that the ellipticity of the polarized light through the compensation layer cannot be measured. In an embodiment of the invention, however, natural light is applied at a given incidence angle as shown in FIG. 5(a) so that the polarizer can produce polarization, and the polarized light is applied to the compensation layer at the given incidence angle so that axis misalignment can be intentionally produced, which allows measurement of the ellipticity of polarized light through the compensation layer.

For example, ellipticity measurement device 14 may be a retardation film/optical material inspection system (RETS-1200VA) manufactured by Otsuka Electronics Co., Ltd., a retardation measurement system (KOBRA-WPR) manufactured by Oji Scientific Instruments, or the like. The data on the relationship between the azimuth angle and the ellipticity of the polarized light measured with ellipticity measurement device 14 are stored together with the measurement conditions in an ellipticity data storage unit 15. Ellipticity data storage unit 15 may include a volatile or nonvolatile recording medium and typically include a hard disk. The measured data are stored together with data IDs so that they are searchable using the data IDs.

Optical property data extraction unit 16 has the functions of reading the data from optical property data storage unit 12 and extracting a data equal or close to the ellipticity of the polarized light measured with ellipticity measurement device 14. Optical property data extraction unit 16 includes a peak judgment unit 161, an average peak calculation unit 162 and a peak difference calculation unit 163 as functional elements.

Peak judgment unit 161 judges whether all the peak ellipticity values of any measurement sample, which are measured with ellipticity measurement device 14 and stored in ellipticity data storage unit 15, are the same or not. In the case of the ellipticities shown in FIG. 6, for example, it is judged whether the four peak values are the same or not. As a result of the judgment, when all the peak values are the same (FIG. 6 shows a case where all the peak values are the same), optical property data extraction unit 16 extracts an ellipticity data equal or close to the ellipticity (peak value) of the polarized light measured with ellipticity measurement device 14 from the data stored in optical property data storage unit 12 so that optical property data such as a front retardation R₀, a thickness retardation Rₜₕ and an average tilt angle β at a bonding angle θ of 0° can be determined. The case where the peak values are the same means that no axis misalignment occurs.

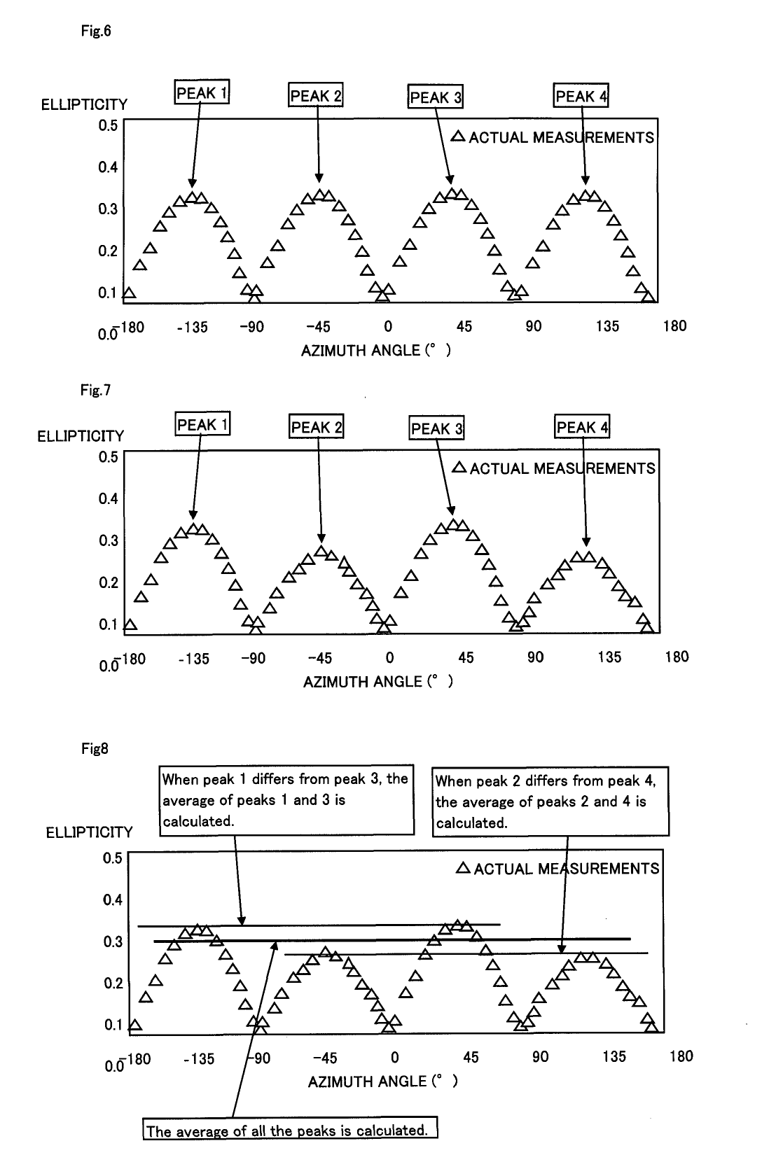

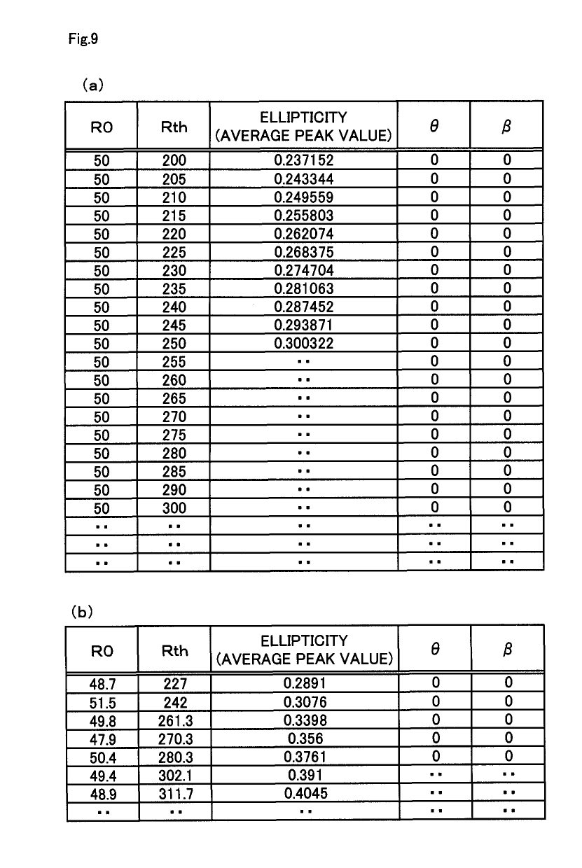

As a result of the judgment, when it is determined that the peak ellipticity values are not the same (in the case shown in FIG. 7, peaks 1 and 3 form a maximum peak pair, while peaks 2 and 4 form a minimum peak pair), average peak calculation unit 162 calculates the average of the peak values (see FIG. 8). Optical property data extraction unit 16 then extracts an ellipticity data equal or close to the calculated average peak value from the data stored in optical property data storage unit 12 so that other optical property data such as a front retardation R₀, a thickness retardation Rₜₕ and an average tilt angle β can be determined.

When the peak ellipticity values are not the same, the bonding angle θ may be determined as described below.

Peak difference calculation unit 163 calculates the difference between the maximum or minimum peak value and the average peak value calculated by average peak calculation unit 162. Optical property data extraction unit 16 then extracts a data equal or close to the difference calculated by peak difference calculation unit 163 from the data on peak ellipticity versus bonding angle θ shift stored in optical property data storage unit 12 so that the bonding angle θ that indicates the axis misalignment in the bonding process can be determined. The data on peak ellipticity versus bonding angle θ shift may be calculated by simulation or actually measured using samples prepared at bonding angles of ±0.5°, 1°, 1.5°, 2°, 2.5°, 3°, and so on, respectively.

A display unit 17 has the function of displaying, on a monitor 18, the optical property data extracted by optical property data extraction unit 16. Display unit 17 also has the function of displaying the operation of system 1, the data input operation and other information on monitor 18.

Optical property data extraction unit 16, data correction unit 13l and display unit 17 may be implemented by software programs, and in such a case, their functions may be implemented in cooperation with hardware resources such as processors and memories (not shown). Alternatively, optical property data extraction unit 16, data correction unit 13l and display unit 17 may be implemented by a dedicated circuit, firmware, or a combination thereof.

An ellipticity calculation unit 21 may be used to calculate the ellipticity of the polarized light through the compensation layer of the optical film or through the compensation layer alone. For example, ellipticity calculation unit 21 may be implemented by simulation software, LCD Master Simulation System manufactured by Shintec Co., Ltd. According to the simulation, measurement conditions such as front retardation R₀, thickness retardation Rₜₕ, bonding angle θ, average tilt angle β, natural light wavelength, and azimuth angle may be set so that the ellipticity of the polarized light can be readily calculated with respect to azimuth angle. The optical property data obtained by means of LCD Master Simulation System may be transmitted to the system 1 using a communication device (not shown). FIG. 9(a) shows exemplary data obtained by means of LCD Master Simulation System. For example, the data are calculated by a process that includes calculating ellipticity data (average peak ellipticities) at a constant R₀ while changing Rₜₕ with a desired pitch, and then calculating ellipticity data (average peak ellipticities) at a different R₀ while changing Rₜₕ with a desired pitch in the same manner. Similarly, data can also be readily calculated while θ or β is changed in a similar manner.

An optical property data measurement means 22 includes a device for measuring various optical properties of the compensation layer alone or any other appropriate device. Examples of optical property data measurement means 22 include a device for measuring front retardation R₀ and thickness retardation Rₜₕ, such as a known retardation measurement system, and a device for measuring average tilt angle β, such as a retardation measurement system (KOBRA-21ADH) manufactured by Oji Scientific Instruments. The optical property data measured by optical property data measurement means 22 are stored in the optical property data storage unit 12 using the input unit 11. FIG. 9(b) shows exemplary actual measurement data. In actual measurement, R₀, Rₜₕ, θ, β, and so on may be previously set in preparation of samples, but preparation of all necessary samples requires a large amount of labor. Therefore, samples should preferably be prepared so that at least peak ellipticity values can be measured.

As used herein, the term “front retardation R₀” refers to the retardation in a direction perpendicular to the compensation layer plane, the term “thickness retardation Rₜₕ” refers to the retardation in the direction of the thickness of the compensation layer, and the term “average tilt angle β” refers to the tilt angle of an optical axis with respect to the sample plane.

System Operation Flow

The data on the optical properties of the compensation layer are previously stored in optical property data storage unit 12 by the method described above (S1). The corrected data and the complementary data produced by data correction unit 13l are also stored.

The ellipticity of an optical film sample is measured at each specific azimuth angle (S2). The ellipticity data measured at each azimuth angle are stored in ellipticity data storage unit 15 (S3). The azimuth angle values are preselected, and, for example, the measurement may be performed at an interval of 1°, 2°, 3°, 4°, or 5°.

The optical property data extraction unit 16 then reads the ellipticity data from ellipticity data storage unit 15 and determines whether all the peak values are the same or not (S4). When the peak values are the same, the process goes to step S5. When the peak values are not the same, the process goes to step S7. Step S5 includes reading data from optical property data storage unit 12 and then extracting an ellipticity data equal or close to the measured ellipticity data from the read data (S5). The data to be read from optical property data storage unit 12 may be preselected. For example, setting may be made so that one or more of simulation data, actual measurement data, corrected data, and complementary data can be used. When different groups of data are read, extraction may be implemented so that corresponding different data can be extracted.

When an ellipticity data equal or close to the measured ellipticity data is extracted from the data read from optical property data storage unit 12, optical property data associated with the ellipticity data (front retardation R₀, thickness retardation Rₜₕ, bonding angle θ=0, average tilt angle β) are then determined in step S5. The optical properties of the compensation layer of the optical film sample are determined by this process. The process of comparing the measured data with the previously prepared and stored data may include comparing peak ellipticity values and comparing the corresponding azimuth angles at the peak values. Alternatively, the process may include calculating approximate curves for the ellipticity-azimuth angle relationship and comparing the approximate curves with each other. In the comparison between the approximate curves, for example, they may be determined to be the same or close to each other when the degree of overlap (the degree of agreement) between the approximate curves exceeds a given value.

The optical property data (front retardation R₀, thickness retardation Rₜₕ, bonding angle θ, and average tilt angle β) determined in step S5 are then displayed on monitor 18 (S6).

In step S7, the average peak value is calculated (S7). The difference between the average peak value and the maximum peak vale or the minimum peak vale is then calculated (S8). Data are then read from optical property data storage unit 12, and an ellipticity data equal or close to the average peak vale of the measured ellipticities is extracted from the read data (S9). As a result, optical property data associated with the ellipticity data (front retardation R₀, thickness retardation Rₜₕ, average tilt angle β) are determined.

Bonding angle θ is then determined. Some disagreement among the measured peak ellipticity values is due to axis misalignment (the bonding angle θ is not zero), and it is necessary to evaluate the axis misalignment. For example, when axis misalignment occurs in the case of a compensation layer satisfying the relation nx>ny>nz, wherein nx is the refractive index in the slow axis direction, ny is the refractive index in the fast axis direction, and nz is the refractive index in the thickness direction, two types of pairs of ellipticity peaks are formed. In this case, azimuth angles at which the maximum or minimum peak pair is formed should be noted. If peak 1 (at an azimuth angle of from −180° to)-90° and peak 3 (at an azimuth angle of from 0 to)90° form the maximum peak pair, the bonding angle θ is shifted in the plus direction (the counterclockwise direction). If peak 1 (at an azimuth angle of from −180° to)-90° and peak 3 (at an azimuth angle of from 0 to)90° form the minimum peak pair, the bonding angle θ is shifted in the minus direction (the clockwise direction).

The difference between the maximum value of the peak pair and the average peak value is then calculated by peak difference calculation unit 163. Data on peak ellipticity versus bonding angle θ shift are read from optical property data storage unit 12, and a data equal or close to the difference calculated by peak difference calculation unit 163 is extracted so that a bonding angle θ that indicates the axis misalignment in the bonding process can be determined. As a result, all the data on the optical properties of the compensation layer of the optical film sample are determined. The determined optical property data are then displayed on monitor 18 (S6). When different results are extracted, the results should be displayed on monitor 18 so as to be recognized by the user.

### Embodiment 2

According to Embodiment 2, there is provided a method of measuring the ellipticities of two types of polarized light using natural light beams with two different wavelengths. Elements specific to Embodiment 2 are described below, while some elements already described for Embodiment 1 are not described or briefly described below.

In ellipticity measurement device 14, natural light beams with two different wavelengths are applied to the sample so that the ellipticities of two types of polarized light can be measured. For example, the two wavelengths are 450 nm and 590 nm. The measured data are associated with wavelength IDs and stored in ellipticity data storage unit 15.

Simulation data or actual measurement data obtained using natural light beams with different wavelengths (for example, 450 nm and 590 nm) are previously stored in optical property data storage unit 12.

Optical property data extraction unit 16 reads simulation data or actual measurement data from optical property data storage unit 12 and subjects the read data to extraction. Optical property data extraction unit 16 then reads the measured ellipticities of the two types of polarized light from ellipticity data storage unit 15 and determines whether all the peaks are the same or not as described above. When all the peaks are the same, the extraction process is performed at each wavelength based on the peak.

When the peaks are not the same, the average of the peak values at each wavelength is calculated, and the extraction process is performed at each wavelength based on the average peak ellipticity.

In this embodiment, two types of data are extracted at two wavelengths in the extraction process so that different samples can produce different results, which allow precise evaluation of the optical property data.

### Embodiment 3

According to Embodiment 3, there is provided a method of measuring the ellipticities of two types of polarized light using two different incidence angles. Elements specific to Embodiment 3 are described below, while some elements already described for Embodiment 1 or 2 are not described or briefly described below.

In ellipticity measurement device 14, natural light is applied at two different incidence angles to the sample so that the ellipticities of two types of polarized light can be measured. For example, the incidence angles are any angles in the range of from 10° to 80° with respect to the horizontal plane of the optical film. The measured data are associated with incidence angle IDs and stored in ellipticity data storage unit 15.

Simulation data or actual measurement data obtained using different incidence angles are previously stored in optical property data storage unit 12.

Optical property data extraction unit 16 reads simulation data or actual measurement data from optical property data storage unit 12 and subjects the read data to extraction. Optical property data extraction unit 16 then reads the measured ellipticities of the two types of polarized light from ellipticity data storage unit 15 and determines whether all the peaks are the same or not as described above. When all the peaks are the same, the extraction process is performed at each wavelength based on the peak.

When the peaks are not the same, the average of the peak values at each wavelength is calculated, and the extraction process is performed at each wavelength based on the average peak ellipticity.

In this embodiment, two types of data are extracted at two incident lights in the extraction process so that different samples can produce different results, which allow precise evaluation of the optical property data.

While the method of the invention has been described using some embodiments including system 1 described above, the embodiments are not intended to limit the scope of the invention. In the method of the invention, some procedures may be manually implemented. For example, the step of extracting an optical property data equal or close to the ellipticity of the polarized light measured by the measurement means from the data prepared in the optical property data preparing step does not have to be automatically performed using an information processor, and a graph showing the relationship between the ellipticity of polarized light and the azimuth angle (see FIGS. 6 to 8) may be prepared from the data prepared in the optical property data preparing step and the actual measurement data on the measurement sample, and used to determine agreement or approximation.

### Example 1

Data on the optical properties of a compensation layer satisfying the relation nx>ny>nz, wherein nx is the refractive index in the slow axis direction, ny is the refractive index in the fast axis direction, and nz is the refractive index in the thickness direction, were prepared by simulation using LCD Master. An optical property database was created using front retardations R₀ between 40 nm and 60 nm at intervals of 5 nm (five front retardations), thickness retardations Rₜₕ between 200 nm and 305 nm at intervals of 5 nm (22 thickness retardations), β=0, θ between 0 and ±5°, and two wavelengths (450 nm and 590 mm).

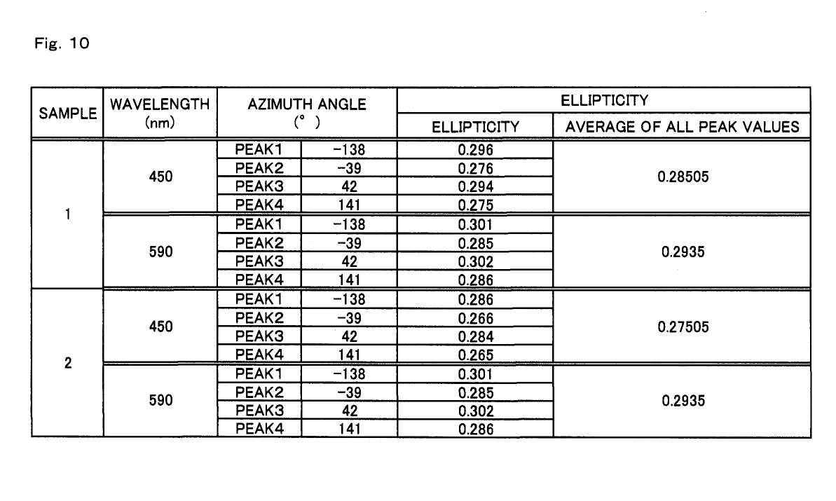

The measurement sample (sample 1) was an optical film prepared by laminating a polarizing plate and a compensation layer satisfying the relation nx>ny>nz, wherein nx was the refractive index in the slow axis direction, ny was the refractive index in the fast axis direction, and nz was the refractive index in the thickness direction. The system 1 described above was used to evaluate the optical properties of the compensation layer. RETS-1200VA (manufactured by Otsuka Electronics Co., Ltd.) was used as the ellipticity measurement device. In the process of measuring the sample, the ellipticity was measured at two wavelengths (450 nm and 590 nm). The measurement data are shown in FIG. 10. Peaks 1 and 3 form a maximum peak pair, while peaks 2 and 4 form a minimum peak pair. The average of all the peak values varies with the wavelength.

The extraction process is performed at each wavelength. Optical property data, a front retardation R₀ and a thickness retardation Rₜₕ, at each of the wavelengths 590 nm and 450 nm are extracted. Since the maximum and minimum peak pairs are formed, it is found that axis misalignment (a defect in bonding between the compensation layer and the polarizer) occurs in the optical film. The difference between the maximum peak value and the average peak value is calculated, and a bonding angle θ (for example, +1°) is extracted according to the difference. The compensation layer satisfying the relation nx>ny>nz, wherein nx is the refractive index in the slow axis direction, ny is the refractive index in the fast axis direction, and nz is the refractive index in the thickness direction, has a β value of zero.

A different sample (sample 2) is prepared and subjected to measurement of the ellipticity in the same manner as described above. A front retardation R₀ and a thickness retardation Rₜₕ at each of the wavelengths 590 nm and 450 nm are extracted. In this example, the measured ellipticities of samples 1 and 2 are the same at a wavelength of 590 nm but different at a wavelength of 450 nm. Therefore, the extraction process for sample 2 should be performed based on the ellipticity at a wavelength of 450 nm. In the case of sample 1, two front retardations R₀ and two thickness retardations Rₜₕ are extracted. When sample 2 is added, however, the front retardation R₀ and the thickness retardation Rₜₕ extracted based on the ellipticity at a wavelength of 450 nm can be evaluated as valid.

1. A method for evaluating the optical properties of a compensation layer in an optical film comprising at least a polarizer and the compensation layer placed thereon, comprising the steps of:
preparing the optical property data that represent the relationship between the ellipticity of polarized light and optical properties of the compensation layer, wherein the optical properties include front retardation R₀, thickness retardation Rₜₕ, bonding angle θ, and average tilt angle β;
measuring the ellipticity of polarized light through a sample of the optical film,;
extracting the optical property data equal or close to the measured ellipticity of the polarized light from the data prepared in the data preparing step,
wherein the ellipticity measuring step, natural light is applied to a polarizer side surface of the optical film at a given angle with respect to a horizontal surface of the optical film, and the optical film is rotated about a vertical axis of the horizontal surface of the optical film, when the ellipticity of the polarized light is measured.

2. The method of claim 1, wherein the optical property data preparing step further comprises the step of theoretically calculating data representing the relationship between the ellipticity of polarized light and the optical properties including front retardation R₀, thickness retardation Rₜₕ, bonding angle θ, and average tilt angle β.

3. The method of claim 1, wherein the optical property data preparing step further comprises the step of measuring, by measurement means, data representing the relationship between the ellipticity of polarized light and the optical properties including front retardation R_{D}, thickness retardation Rₜₕ, bonding angle θ, and average tilt angle β.

4. The method of claim 1, wherein the optical property data preparing step further comprises the steps of:
theoretically calculating data representing the relationship between the ellipticity of polarized light and the optical properties including front retardation R₀, thickness retardation Rₜₕ, bonding angle θ, and average tilt angle β;
measuring, by measurement means, data representing the relationship between the ellipticity of polarized light and the optical properties including front retardation R₀, thickness retardation Rₜₕ, bonding angle θ, and average tilt angle β; and
correcting the calculated data so that the calculated data can be an approximation to the measured data.

5. The method of claim 1, wherein in the optical property data extracting step, when four peak ellipticity values measured in the ellipticity measuring step are the same, a data equal or close to the peak value is extracted from the data prepared in the data preparing step so that the front retardation R₀, thickness retardation Rₜₕ, and average tilt angle β at a bonding angle θ of 0° can be determined.

6. The method of claim 1, wherein in the optical property data extracting step, when four peak ellipticity values measured in the ellipticity measuring step are not the same, the average of the peak values is calculated, and a data equal or close to the calculated average peak value is extracted from the data prepared in the data preparing step so that the front retardation R₀, thickness retardation Rₜₕ, and average tilt angle β can be determined.

7. The method of claim 6, wherein the difference between the calculated average peak value and a maximum or minimum peak value is calculated, and a data equal or close to the calculated difference is extracted from data on peak ellipticity versus bonding angle θ shift prepared in the data preparing step so that the bonding angle θ indicating axis misalignment in a bonding process can be determined

8. The method of claim 1, wherein
the ellipticity measuring step comprises applying natural light to a polarizer side surface of the optical film at two different angles with respect to the horizontal surface of the optical film to measure the ellipticities of two types of polarized light, and
the optical property data extracting step comprises extracting a data equal or close to each of the measured ellipticities of the two types of polarized light from the data prepared in the data preparing step.

9. The method of claim 1, wherein
the ellipticity measuring step comprises using natural light with two different wavelengths to measure the ellipticities of two types of polarized light, and
the data extracting step comprises extracting a data equal or close to each of the measured ellipticities of the two types of polarized light from the data prepared in the data preparing step.

10. The method of claim 1, wherein the compensation layer satisfies the relation nx>ny>nz, wherein nx is its refractive index in its slow axis direction, ny is its refractive index in its fast axis direction, and nz is its refractive index in its thickness direction.

11. A system for evaluating the optical properties of a compensation layer in an optical film comprising at least a polarizer and the compensation layer placed thereon, comprising:
an optical property data storage unit for storing data that represent the relationship between the ellipticity of polarized light and optical properties of the compensation layer, wherein the optical properties include front retardation R₀, thickness retardation Rₜₕ, bonding angle θ, and average tilt angle β;
an ellipticity measurement device for measuring the ellipticity of polarized light through a sample of the optical film;
an optical property data extraction unit for extracting a data equal or close to the measured ellipticity of the polarized light from the data stored in the optical property data storage unit,
wherein measuring by the ellipticity measurement device, natural light is applied to a polarizer side surface of the optical film at a given angle with respect to a horizontal surface of the optical film, and the optical film is rotated about a vertical axis of the horizontal surface of the optical film, when the ellipticity of the polarized light is measured.
